(19) United States
(12) Patent Application Publication
(10) Pub. No.: US 2026/0116151 A1
(43) Pub. Date: Apr. 30, 2026

(54) Parking Heater with High Energy Utilization Rate

(71) Applicant: Rui'an Ruihai Automotive Heater Manufacturing Co., Ltd, Wenzhou (CN)

(72) Inventor: Caiyun HU, Wenzhou (CN)

(73) Assignee: Rui'an Ruihai Automotive Heater Manufacturing Co., Ltd, Wenzhou (CN)

(21) Appl. No.: 18/925,098

(22) Filed: Oct. 24, 2024

(51) Int. Cl. B60H 1/22; F02N 19/02

(52) U.S. Cl. CPC B60H 1/2212; F02N 19/02

(57) ABSTRACT

A parking heater with a high energy utilization rate comprises a shell and a combustion device. The combustion device is installed in the shell and has a gap, which is set as an airflow channel, and the shell is provided with at least one air inlet communicated with the airflow channel; the combustion device comprises a cylinder body and an exhaust gas pipeline, and the cylinder body is provided with a combustion chamber and a fuel pipeline; wherein, the fuel pipeline is used for communicating with the combustion chamber and providing fuel.

### TECHNICAL FIELD

The present disclosure relates to the technical field of parking heaters, in particular to a parking heater with a high energy utilization rate.

### BACKGROUND

Parking heater is an independent auxiliary heating system, which can preheat and raise the temperature of the vehicle without starting the engine, and can also provide auxiliary heating function during driving. The use of parking heaters has many advantages, such as avoiding cold start of vehicles, prolonging the service life of engines; ensuring that fuel economy; and improving security and the like. Parking heater is very practical for automobile travel in cold weather, which can not only protect the engine, but also improve the comfort and safety of passengers.

The parking heater has its own fuel pipeline, circuit, combustion heating device and control device. After the gas enters the parking heater from the air inlet pipe for combustion, the burnt exhaust gas is directly discharged from the vehicle through the exhaust gas pipeline, and the nozzle of the exhaust gas pipeline is provided on the shell of the parking heater. Because the burnt exhaust gas has a high temperature, and the temperature at the nozzle is as high as 400 to 500℃, there is a great energy waste problem in this waste gas treatment method. For example, the European patent No. 21735565 has the problem of energy waste, and it is slow to heat the vehicle; similarly, the European patent No. 0632769 also has the characteristics of low energy utilization rate, which may cause energy waste and slow heating of the vehicle.

In view of the above problems, there is a need to propose a new type of parking heater, which has less energy waste, saves fuel, can effectively raise the temperature inside the vehicle, and provides users with better use experience and more cost-effective parking heater selection.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides a parking heater with a high energy utilization rate to solve the problems of heat waste and slow heating mentioned in the background technology.

In order to achieve the above object, the present disclosure provides a parking heater with a high energy utilization rate, which includes a shell and a combustion device; the shell includes at least one air inlet end and at least one air outlet end, and an air flow channel communicated with the air inlet end and the air outlet end; and the combustion device includes a cylinder body and an exhaust gas pipeline, and the cylinder body is provided with a combustion chamber, a fuel pipeline, an input end and an output end; the fuel pipeline is communicated with the combustion chamber, the input end defines a channel for air to enter the combustion chamber, the output end defines a channel for exhaust gas after combustion to exit from the combustion chamber, and the output end is communicated with the exhaust gas pipeline; the combustion chamber includes a combustion cylinder with a cylindrical structure with a varying axial diameter, and the fuel pipeline is continuously formed around the cylindrical structure of the combustion cylinder; the exhaust gas pipeline extends to the air inlet end and is continuously formed around an air inlet channel of the air inlet end.

The present disclosure further provides a parking heater with a high energy utilization rate, which includes a shell and a combustion device; the combustion device is installed in the shell and has a gap, which is set as an air flow channel, and the shell is provided with at least one air inlet end communicated with the air flow channel; the combustion device includes a cylinder body and an exhaust gas pipeline, and the cylinder body is provided with a combustion chamber and a fuel pipeline; the fuel pipeline is configured for communicating with the combustion chamber and providing fuel, and the exhaust gas pipeline is configured for communicating with the combustion chamber and receiving exhaust gas; the combustion chamber includes a combustion cylinder with a cylindrical structure with a varying axial diameter, and the fuel pipeline is continuously formed around the cylindrical structure of the combustion cylinder; the exhaust gas pipeline extends to the air inlet end and is continuously formed around an air inlet channel of the air inlet end.

The present disclosure further provides a parking heater with a high energy utilization rate, which includes a shell and a combustion device; the combustion device is installed in the shell and has a gap, which gap is set as an air flow channel, and the shell is provided with at least one air inlet communicated with the air flow channel; the combustion device includes a cylinder body and an exhaust gas pipeline, and the cylinder body is provided with a combustion chamber and a fuel pipeline; the fuel pipeline is configured for communicating with the combustion chamber and providing fuel, and the exhaust gas pipeline is configured for communicating with the combustion chamber and receiving exhaust gas; the exhaust gas pipeline extends to the air inlet end and is continuously formed around an air inlet channel of the air inlet end.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of a parking heater of the present disclosure.

FIG. 2 is a schematic diagram of the shell of the present disclosure.

FIG. 3 is a schematic view of the second shell of the present disclosure.

FIG. 4 is a schematic diagram of the parking heater of the present disclosure without a shell.

FIG. 5 is an exploded view of the motor assembly of the present disclosure.

FIG. 6 is another exploded view of the motor assembly of the present disclosure.

FIG. 7 is a schematic diagram of the cylinder body of the present disclosure.

FIG. 8 is a schematic diagram of the combustion device of the present disclosure.

FIG. 9 is a schematic view of the combustion seat of the present disclosure.

Reference signs: Shell (1000); First shell (1001); Second shell (1002); Fixing slot (1003); Fixing block (1004); Accommodating slot (1005); Embedding slot (1101); Sixth fixing hole (1102); Air inlet end (1106); Air outlet end (1107); Heat conducting rib (1108); Cylinder body (2000); Exhaust port (2001); Pipeline fixing platform (2002); First groove (2003); Second groove (2004); Third groove (2005); Spare port (2006); Air valve cover (2007); First sealing ring (2008); Connecting pipe (2009); Second sealing ring (2010); Pipeline slot (2011); Eighth fixing hole (2012); Second fixing hole (2101); Fifth fixing hole (2102); Motor assembly (3000); Motor base (3001); Air inlet pipe (3002); Combustion-supporting wind wheel (3003); Motor (3004); Auxiliary wind wheel (3005); Exhaust gas pipeline (3006); Motor slot (3007); Collar part (3008); Abutment ring (3009); Support column (3010); Support part (3011); First fixing hole (3101); Fourth fixing hole (3102); Third fixing hole (3103); Snap-in protrusion (3104); Twelfth fixing hole (3105); Combustion device (4000); Combustion seat (4001); Combustion cylinder (4002); Ignition device (4003); Air deflector (4004); Mixed combustion cavity (4005); Cyclone air outlet (4006); Blade (4007); Ignition pipeline (4008); Vent hole (4009); External thread (4010); Internal thread (4011); Combustion chamber (4012); Input end (4013); Output end (4014); Seventh fixing hole (4101); Control device (5000); Control panel (5001); Control backplane (5002); Ninth fixing hole (5101); Tenth fixing hole (5012); Buckle slot (5103); Eleventh fixing hole (5104); Fuel pipeline (6000); Pipeline body (6001); Conveying end (6002); Feeding end (6003); Fitting part (6101); Pipeline hole (6102).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

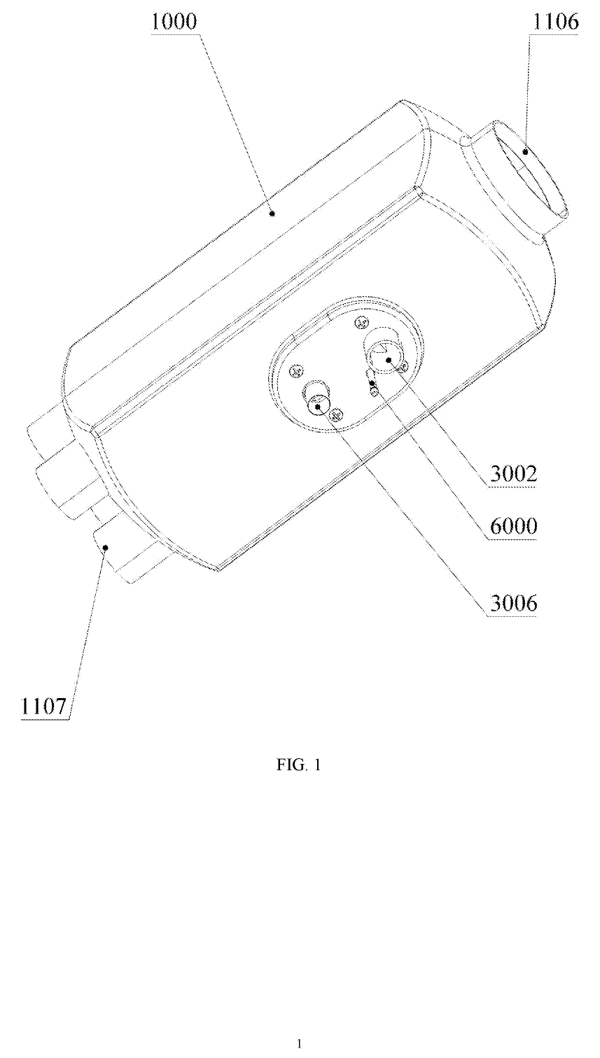

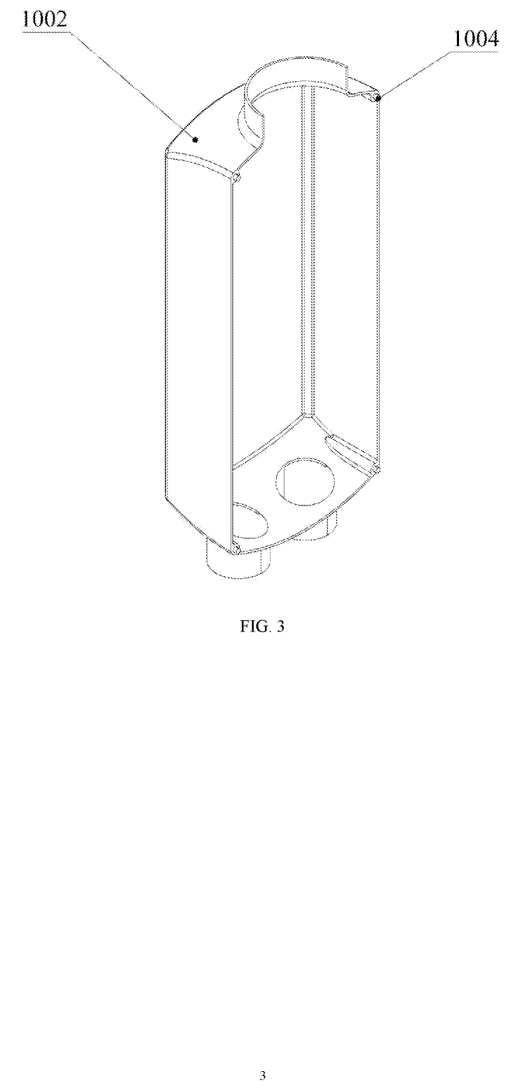

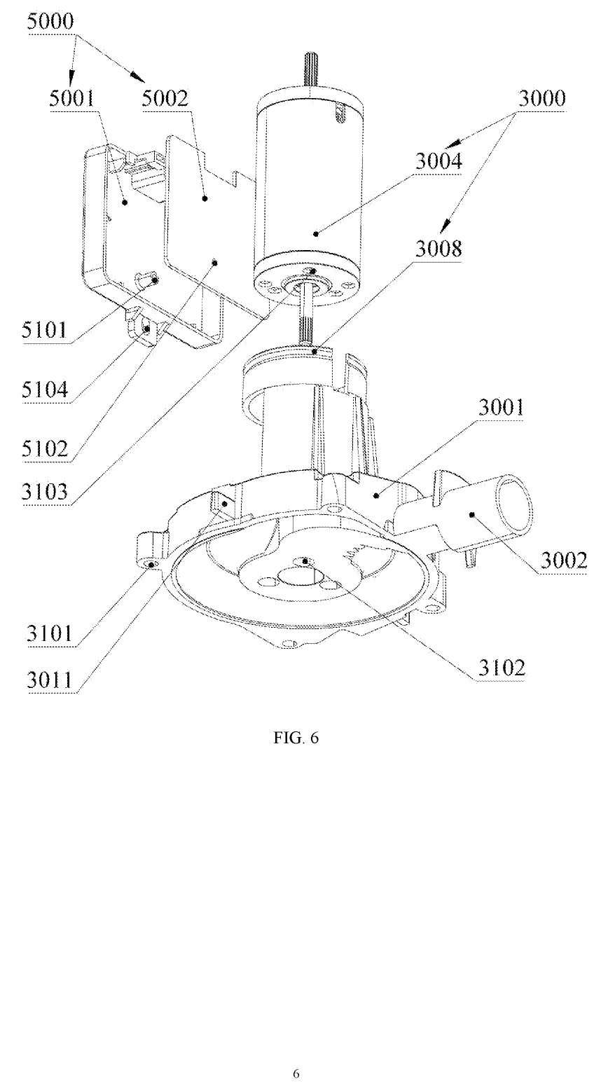

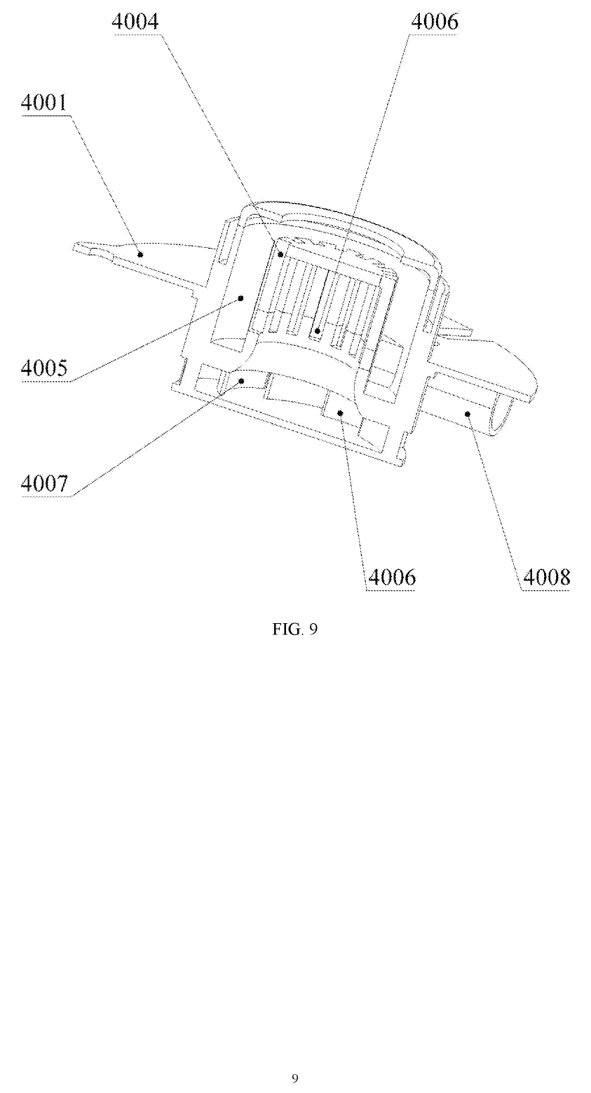

As shown in FIGS. 1 to 9, the present disclosure provides a parking heater with a high energy utilization rate, including a shell 1000 and a combustion device 4000. The shell 1000 includes at least one air inlet end 1106 and at least one air outlet end 1107, and an air flow channel running through the air inlet end 1106 and the air outlet end 1107. The combustion device 4000 includes a cylinder body 2000, which includes a combustion chamber 4012, a fuel pipeline 6000, an exhaust gas pipeline 3006, an input end 4013 and an output end 4014. The fuel pipeline 6000 is communicated with the combustion chamber 4012, the input end 4013 defines a channel for air to enter the combustion chamber 4012, and the output end 4014 defines a channel for burned exhaust gas to exit from the combustion chamber 4012. The combustion chamber 4012 includes a combustion cylinder 4002, which has a cylindrical structure with a varying axial diameter, and the fuel pipeline 6000 is continuously molded around the cylindrical structure of the combustion cylinder 4002. The exhaust gas pipeline 3006 extends to the air inlet end 1106 and is continuously formed around the air inlet channel of the air inlet end 1106.

In this embodiment, the exhaust gas pipeline 3006 is made of a material with high thermal conductivity, and the exhaust gas pipeline 3006 can receive the exhaust gas generated during combustion in the combustion cylinder 4002, and then the exhaust gas is discharged to the outside. While the exhaust gas pipeline 3006 discharges the exhaust gas, the heat in the exhaust gas will be transferred to the exhaust gas pipeline 3006, and then the heat will be dissipated into the shell 1000 through the exhaust gas pipeline 3006, and then the heat in the shell 1000 will be discharged to the cab through the air outlet end 1107. Therefore, in this way, the heat in the exhaust gas can be reused, and the heat utilization rate is improved, which has excellent energy saving and emission reduction effects.

In some embodiments (not shown), in order to improve the heat dissipation capacity of the exhaust gas pipeline 3006, heat dissipation fins may also be provided on the outer wall of the exhaust gas pipeline 3006. The contact area between the exhaust gas pipeline 3006 and the air can be increased by arranging the heat dissipation fins, so that the heat dissipation is faster and the air heating effect is better.

In this embodiment, the combustion cylinder 4002 is provided in a cylindrical shape. In other embodiments (not shown), the combustion cylinder 4002 may also be set into a triangle, an ellipse, a rectangle, a polygon, and any desired geometric shape.

In this embodiment, the exhaust gas pipeline 3006 is wound on the motor 3004. In other embodiments (not shown), the exhaust gas pipeline 3006 is not limited to being wound on the motor assembly 3000, but may be provided to be bent and wound at any position corresponding to the air inlet end 1106 in the shell 1000.

In this embodiment, the exhaust gas pipeline 3006 and the fuel pipeline 6000 are provided as circular pipelines. In other embodiments (not shown), the exhaust gas pipeline 3006 and the fuel pipeline 6000 are not limited to circular pipelines, but may also be configured to be triangular, elliptical, rectangular, polygonal, and any desired geometric shapes. With the polygonal shape, the contact area can be further increased and the heat transfer efficiency can be improved.

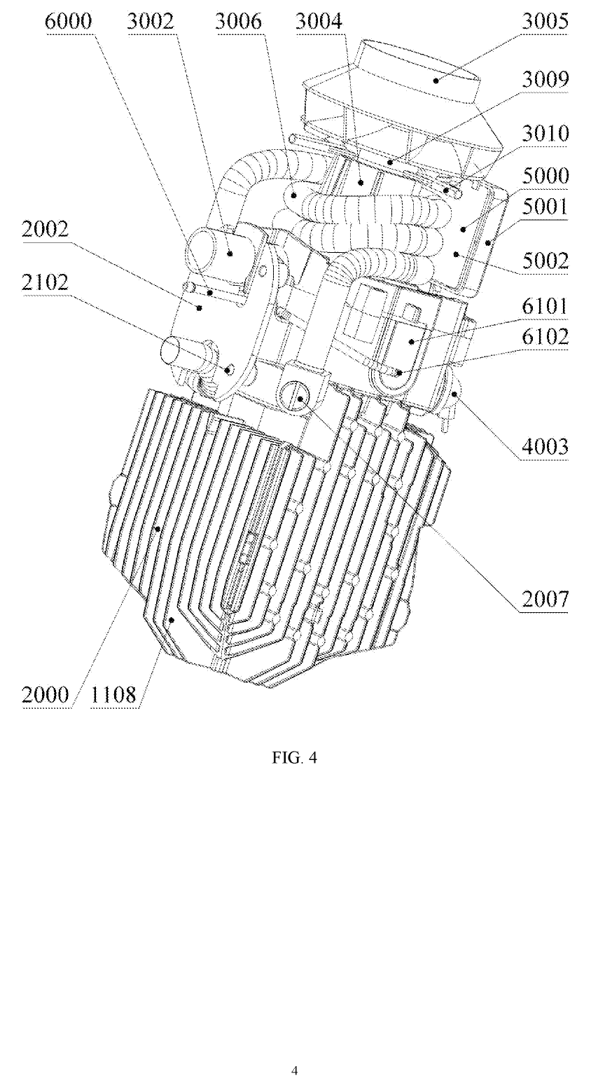

As shown in FIGS. 4 to 8, in this embodiment, the combustion chamber 4012 includes a combustion seat 4001, a combustion cylinder 4002 sleeved on the upper end of the combustion seat 4001, and an ignition device 4003 installed on the combustion seat 4001. One end of the combustion cylinder 4002 is communicated with the combustion seat 4001, the other end of the combustion cylinder 4002 is open, and the combustion seat 4001 is communicated with the air inlet pipe 3002. The fuel pipeline 6000 includes a pipeline body 6001 wound around the combustion cylinder 4002, a conveying end 6002 connected with the ignition device 4003, and a feeding end 6003 located outside the shell 1000.

In some embodiments (not shown), a fire net is provided at the opening to prevent the flame from overflowing; a temperature sensor is also provided at the opening to detect the flame temperature and feed it back to the control device 5000; a plurality of nozzles are provided on the pipeline body 6001, and the nozzles face the inside of the combustion cylinder 4002 and are evenly distributed along the axial direction of the combustion cylinder 4002; the conveying end 6002 is provided with a valve and a pump to control and deliver fuel; a filter and a storage tank are provided at the feeding end 6003 to filter and store fuel.

In some embodiments (not shown), an igniter and an ignition circuit are provided in the ignition device 4003. The igniter includes an electrode and an insulating sleeve. The electrode passes through the vent hole 4009 of the ignition pipeline 4008 and extends into the mixed combustion cavity 4005. The insulating sleeve wraps the electrode and is closely connected with the ignition pipeline 4008. The ignition circuit includes a power supply, a switch, a transformer and a capacitor, wherein the power supply is sequentially connected with the switch, the transformer and the capacitor, and the output end of the transformer is connected to the electrode.

As shown in FIGS. 4 to 9, in this embodiment, an air deflector 4004 with a gas inlet cavity is provided in the combustion seat 4001, a mixed combustion cavity 4005 is formed between the air deflector 4004 and the inner wall of the combustion seat 4001. A plurality of cyclone air outlets 4006 are provided at intervals on the surface of the air deflector 4004, and a plurality of blades 4007 are provided at the lower end of the combustion seat 4001 in a vortex shape along the cavity opening of the gas inlet cavity. An ignition pipeline 4008 for installing the ignition device 4003 is provided in the combustion seat 4001. The ignition pipeline 4008 is communicated with the mixed combustion cavity 4005, and the fuel pipeline 6000 is communicated with the ignition pipeline 4008, wherein the ignition pipeline 4008 is provided with a vent hole 4009.

As shown in FIGS. 4 to 7, in this embodiment, a motor assembly 3000 is connected to the cylinder body 2000, and a control device 5000 is provided on the motor assembly 3000. The motor assembly 3000 includes a motor base 3001 connected to the cylinder body 2000, and an air inlet pipe 3002 with one end passing through the shell 1000 is provided on the motor base 3001.

A combustion-supporting wind wheel 3003 is installed at one end of the motor base 3001 facing the combustion device 4000, and a motor 3004 is provided at the other end of the motor base 3001. An auxiliary wind wheel 3005 is provided at one end of the motor 3004 far from the motor base 3001. The exhaust gas pipeline 3006 is wound around the motor 3004, one end of the exhaust gas pipeline 3006 is connected with the exhaust port 2001 provided on the cylinder body 2000, and the other end of the exhaust gas pipeline 3006 passes through the shell 1000 and is communicated with the outside. The cylinder body 2000 is provided with a plurality of heat conducting ribs 1108 to increase the contact area between air and the cylinder body 2000 and improve the heating efficiency.

In some embodiments (not shown), a filter screen and an anti-freezing device are provided inside the air inlet pipe 3002 to filter impurities in the air and prevent condensation of water vapor. An adjusting valve is provided between the air inlet pipe 3002 and the combustion-supporting wind wheel 3003 to control the air flow into the combustion-supporting wind wheel 3003. A sound insulation layer and a vibration isolation layer are provided between the combustion-supporting wind wheel 3003 and the cylinder body 2000 to reduce noise and vibration. A heat exchanger is provided between the auxiliary wind wheel 3005 and the shell 1000 to cool the shell 1000 with the air blown by the auxiliary wind wheel 3005, and send the air into the air flow channel after preheating. A plurality of spiral flow deflectors are provided inside the heat exchanger to increase the contact area and time between air and the surface of the heat exchanger.

The control device 5000 is provided with a microprocessor, a display screen, buttons, a temperature sensor, a pressure sensor, a flow sensor and other elements, wherein the microprocessor is respectively connected with the display screen, buttons, a temperature sensor, a pressure sensor, a flow sensor and other elements to realize parameter setting, monitoring and control of the parking heater.

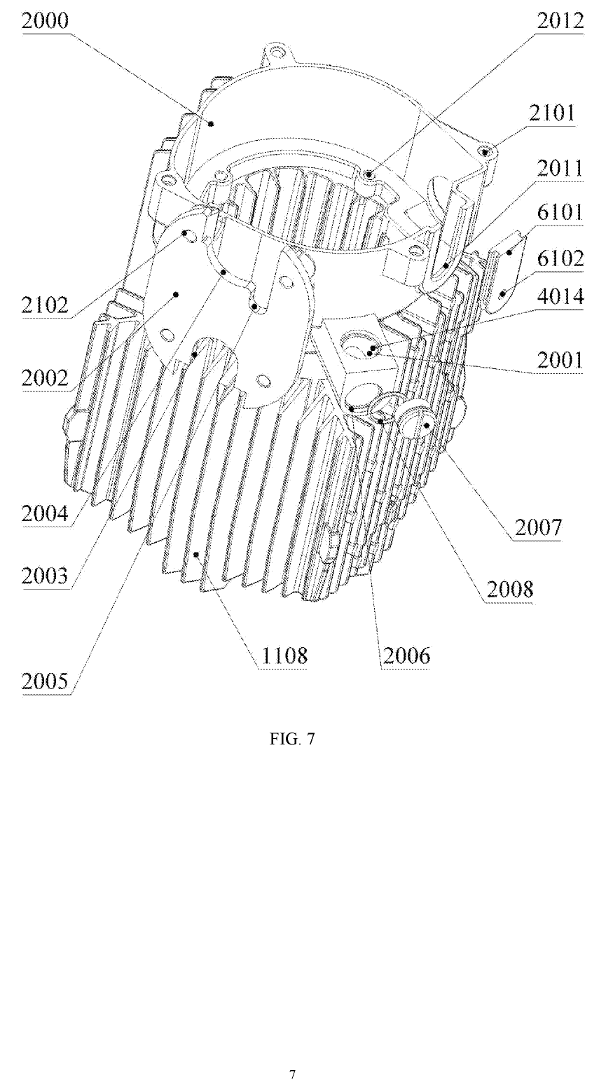

As shown in FIG. 7, in this embodiment, one side of the cylinder body 2000 is provided with a pipeline fixing platform 2002, and the pipeline fixing platform 2002 is provided with a first groove 2003 for fixing the exhaust gas pipeline 3006, a second groove 2004 for fixing the air inlet pipe 3002 and a third groove 2005 for fixing the fuel pipeline 6000. In other embodiments (not shown), it is not limited to fixing the pipelines through the grooves, but through holes may also be provided.

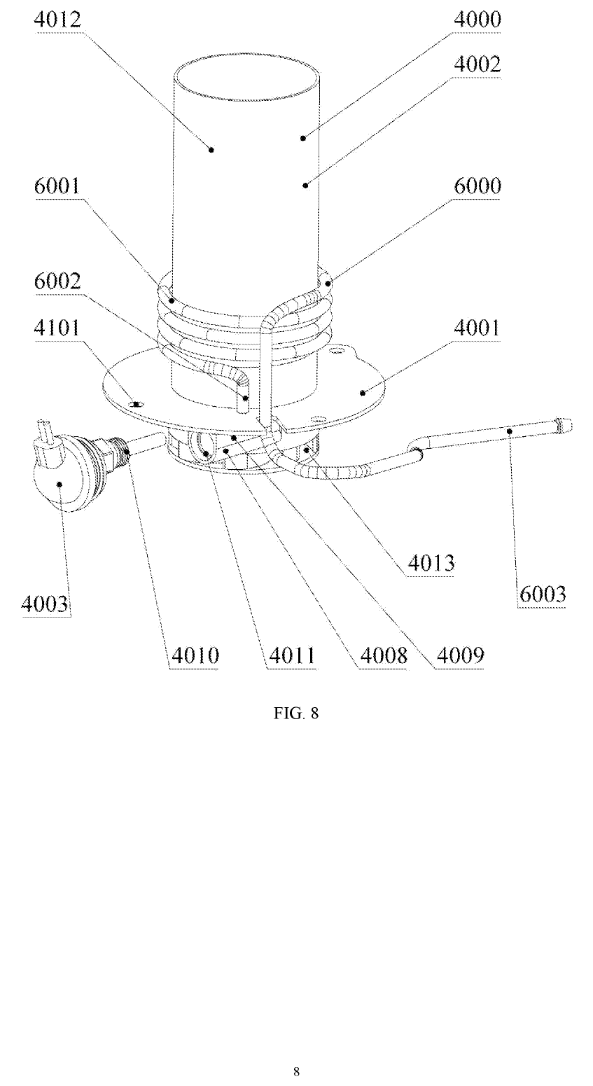

As shown in FIG. 8, in this embodiment, the ignition device 4003 is provided with an external thread 4010, and the ignition pipeline 4008 is internally provided with an internal thread 4011 which is matched with the ignition device 4003. The ignition device 4003 and the ignition pipeline 4008 are detachably connected by threaded connection. In other embodiments (not shown), the connection between the ignition device 4003 and the ignition pipeline 4008 are not limited to the detachable connection by threaded connection, but may also be set as screw connection, pin connection, rivet connection, pin connection, welding and any other desirable connection modes.

As shown in FIGS. 1 to 3, in this embodiment, the shell 1000 includes a first shell 1001 and a second shell 1002 corresponding to the first shell 1001. The first shell 1001 is provided with at least one fixing slot 1003, and the second shell 1002 is provided with at least one fixing block 1004 corresponding to the fixing slot 1003. The first shell 1001 and the second shell 1002 are detachably connected through the fixing slot 1003 and the fixing block 1004. In other embodiments (not shown), the first shell 1001 and the second shell 1002 are not limited to the detachable connection formed by the fixing slot 1003 and the fixing block 1004, but the connection may also be set as screw connection, pin connection, rivet connection, pin connection, welding and any desirable connection modes.

As shown in FIGS. 4 to 7, in this embodiment, at least one first fixing hole 3101 is provided on the motor base 3001, and at least one second fixing hole 2101 corresponding to the first fixing hole 3101 is provided on the cylinder body 2000. The motor base 3001 and the cylinder body 2000 are fixedly connected by a first fixing element. In this embodiment, the first fixing member is set as a screw. In other embodiments (not shown), the motor base 3001 and the cylinder body 2000 are not limited to being fixedly connected by screws, but may also be connected by pins, rivets, welding and any other desirable connection modes.

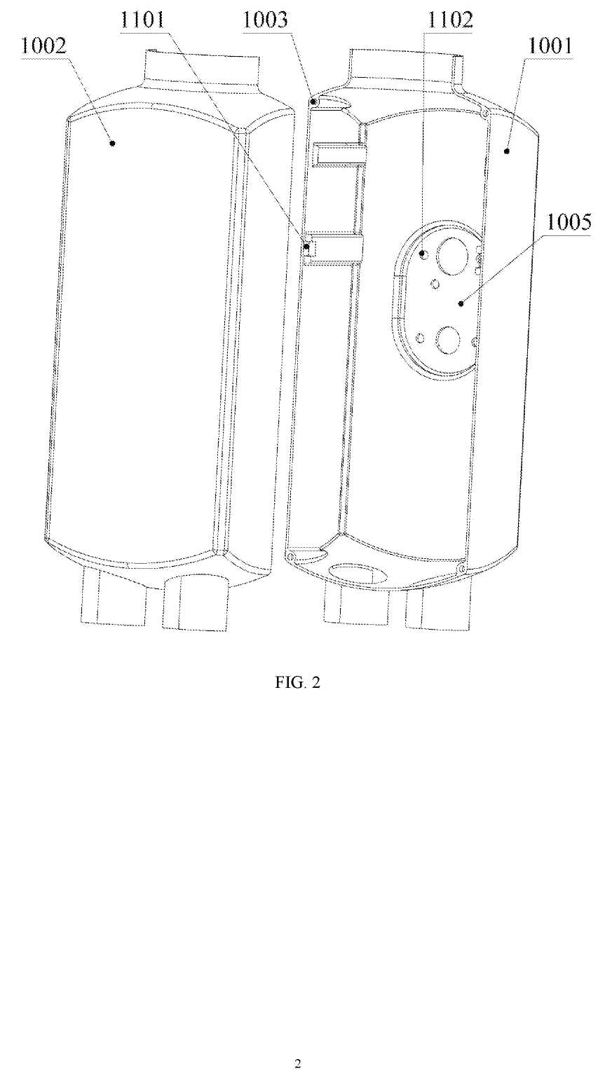

As shown in FIGS. 2 to 7, in this embodiment, the first shell 1001 is provided with an accommodating slot 1005 for accommodating the pipeline fixing platform 2002. The pipeline fixing platform 2002 is provided with at least one fifth fixing hole 2102, and the accommodating slot 1005 is provided with at least one sixth fixing hole 1102 corresponding to the fifth fixing hole 2102. The first shell 1001 and the pipeline fixing platform 2002 are fixedly connected by a third fixing element. In this embodiment, the third fixing member is set as a screw. In other embodiments (not shown), the first shell 1001 and the pipeline fixing platform 2002 are not limited to being fixedly connected by screws, but may also be connected by pins, rivets, welding and any other desirable connection modes.

As shown in FIGS. 4 to 7, in this embodiment, a motor slot 3007 is formed on the motor base 3001, and the motor 3004 is provided in the motor slot 3007. At least one third fixing hole 3103 is provided on the motor base 3001, and at least one fourth fixing hole 3102 corresponding to the third fixing hole 3103 is provided on the motor base 3001. The motor base 3001 and the motor 3004 are connected by a second fixing element. In this embodiment, the second fixing member is set as a screw. In other embodiments (not shown), the motor base 3001 and the motor 3004 are not limited to being fixedly connected by screws, but may also be connected by pins, rivets, welding and any other desirable connection modes.

As shown in FIGS. 4 to 7, in this embodiment, the motor base 3001 is further provided with a collar part 3008, an abutment ring 3009 is provided on the collar part 3008, and a plurality of support columns 3010 abutting on the shell 1000 are provided on the abutment ring 3009. The motor base 3001 is further provided with a support part 3011, the first shell 1001 is provided with an embedding slot 1101 corresponding to the support part 3011, and the support part 3011 is provided in the embedding slot 1101.

As shown in FIGS. 4 to 7, in this embodiment, the control device 5000 includes a control panel 5001 and a control backplane 5002 corresponding to the control panel 5001. The control panel 5001 is provided with at least one ninth fixing hole 5101, and the control backplane 5002 is provided with at least one tenth fixing hole 5102 corresponding to the ninth fixing hole 5101. The control panel 5001 and the control backplane 5002 are fixedly connected by a fifth fixing element. In this embodiment, the fifth fixing member is set as a screw. In other embodiments (not shown), the control panel 5001 and the control backplane 5002 are not limited to being fixedly connected by screws, but may also be connected by pins, rivets, welding and any desirable connection modes.

As shown in FIGS. 4 to 7, in this embodiment, the control panel 5001 is provided with a buckle slot 5103 and an eleventh fixing hole 5104, and the motor base 3001 is provided with a snap-in protrusion 3104 corresponding to the buckle slot 5103 and a twelfth fixing hole 3105 corresponding to the eleventh fixing hole 5104. The control panel 5001 and the motor base 3001 are fixedly connected by snap connection and screw connection. In other embodiments (not shown), the control panel 5001 and the motor base 3001 are not limited to the fixed connection by snap connection and screw connection, but may also be connected by pins, rivets, welding and any other desirable connection modes.

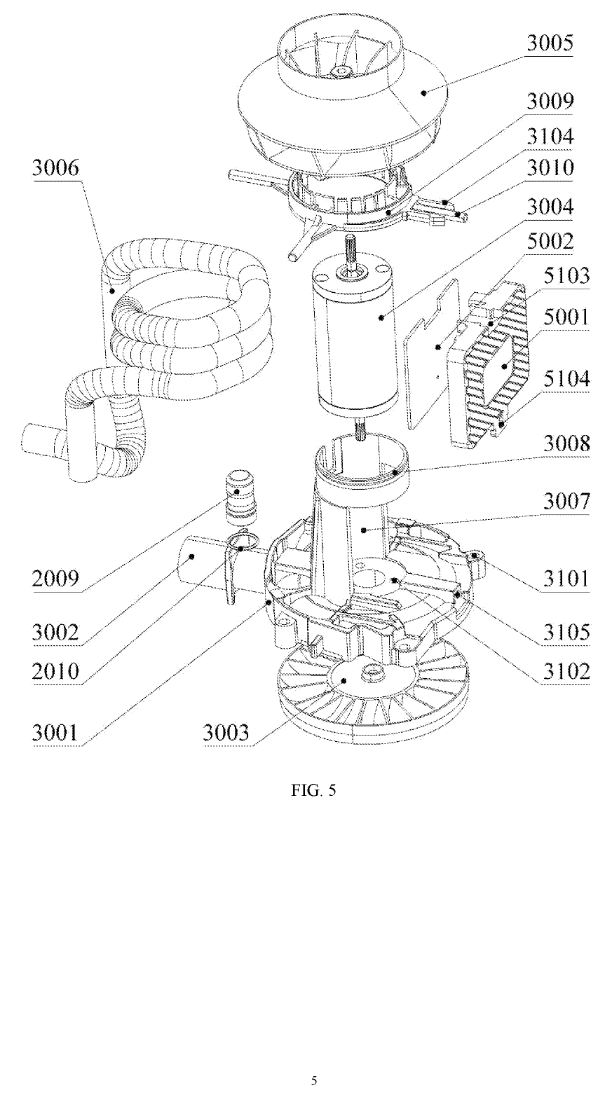

As shown in FIGS. 5 to 7, in this embodiment, a spare port 2006 is provided on the cylinder body 2000, a valve cover 2007 is provided on the spare port 2006, and a first sealing ring 2008 is provided on the valve cover 2007, which can effectively prevent gas leakage. A connecting pipe 2009 corresponding to the exhaust gas pipeline 3006 and the exhaust port 2001 is provided between the exhaust gas pipeline 3006 and the exhaust port 2001, and a second sealing ring 2010 is provided on the connecting pipe 2009, which can effectively isolate the exhaust gas from the outside air.

As shown in FIG. 7, in this embodiment, the cylinder body 2000 is provided with a pipeline slot 2011, and a fitting part 6101 is provided on the pipeline slot 2011. A pipeline hole 6102 corresponding to the fuel pipeline 6000 is provided on the fitting part 6101, and the fuel pipeline 6000 is provided in the pipeline hole 6102 in a penetrating manner.

As shown in FIGS. 7 to 8, in this embodiment, the combustion seat 4001 is provided with at least one seventh fixing hole 4101, and the cylinder body 2000 is provided with at least one eighth fixing hole 2012 corresponding to the seventh fixing hole 4101. The combustion seat 4001 and the cylinder body 2000 are fixedly connected through a fourth fixing element. In this embodiment, the fourth fixing member is provided as a screw. In other embodiments (not shown), the combustion seat 4001 and the cylinder body 2000 are not limited to being fixedly connected by screws, but may also be connected by pins, rivets, welding and any other desirable connection modes.

When the parking heater works, fuel enters the combustion device 4000 from the fuel pipeline 6000, the combustion-supporting wind wheel 3003 works to suck oxygen into the combustion device 4000 from the air inlet pipe 3002; the heat generated by the fuel burning in the combustion device 4000 heats the cylinder body 2000, the cold air enters the interior from the air inlet end 1106 of the shell 1000, and is heated after passing through the cylinder body 2000; the heated hot air enters the cab from the air outlet end 1107 of the shell 1000, and the exhaust gas generated by combustion is discharged from the exhaust gas pipeline 3006; the exhaust gas pipeline 3006 is wound on the motor 3004, so that the exhaust path of the exhaust gas is lengthened, and the auxiliary wind wheel 3005 is allowed to have enough time to blow the heat carried on the exhaust gas pipeline 3006 to the cylinder body 2000, thereby improving the energy utilization rate; in addition, when the fuel burns in the combustion chamber 4012, the combustion cylinder 4002 is heated, and the fuel pipeline 6000 wound around the combustion cylinder 4002 is heated accordingly; when the temperature of the combustion cylinder 4002 reaches a temperature that can gasify the fuel, the fuel in the fuel pipeline 6000 is gasified and enters the combustion chamber 4012 for combustion in a gasified state. The combustion degree of the fuel in the gasified state is more sufficient, and the energy utilization rate is improved.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A parking heater with a high energy utilization rate, comprising a shell and a combustion device, wherein
the shell comprises at least one air inlet end and at least one air outlet end, and an air flow channel communicated with the air inlet end and the air outlet end; and
the combustion device comprises a cylinder body and an exhaust gas pipeline, and the cylinder body is provided with a combustion chamber, a fuel pipeline, an input end and an output end; and
wherein, the fuel pipeline is communicated with the combustion chamber, the input end defines a channel for air to enter the combustion chamber, the output end defines a channel for exhaust gas after combustion to exit from the combustion chamber, and the output end is communicated with the exhaust gas pipeline; and
the combustion chamber comprises a combustion cylinder with a cylindrical structure with a varying axial diameter, and the fuel pipeline is continuously formed around the cylindrical structure of the combustion cylinder; and
the exhaust gas pipeline extends to the air inlet end and is continuously formed around an air inlet channel of the air inlet end.

2. The parking heater with a high energy utilization rate according to claim 1, wherein the combustion chamber further comprises a combustion seat and an ignition device installed on the combustion seat; the combustion cylinder is sleeved at one end of the combustion seat and communicated therewith, while the other end of the combustion cylinder is configured to be open.

3. The parking heater with a high energy utilization rate according to claim 2, wherein the fuel pipeline comprises a pipeline body coiled on the combustion cylinder, a conveying end connected with the ignition device, and a feeding end located outside the shell.

4. The parking heater with a high energy utilization rate according to claim 3, wherein
the combustion seat is internally provided with an air deflector with a gas inlet cavity, a mixed combustion cavity is formed between the air deflector and an inner wall of the combustion seat, and a plurality of cyclone air outlets are provided on a surface of the air deflector at intervals.

5. The parking heater with a high energy utilization rate according to claim 4, wherein the other end of the combustion seat is provided with a plurality of blades distributed in a vortex shape along a cavity opening of the gas inlet cavity, and an ignition pipeline for installing the ignition device is provided in the combustion seat; wherein, the ignition pipeline is communicated with the mixed combustion cavity, and the fuel pipeline is communicated with the ignition pipeline; the ignition pipeline is provided with a vent hole.

6. The parking heater with a high energy utilization rate according to claim 1, wherein the cylinder body is provided with an exhaust port, the cylinder body is connected with a motor assembly, which is provided with a control device.

7. The parking heater with a high energy utilization rate according to claim 6, wherein the motor assembly comprises a motor base connected with the cylinder body, and an air inlet pipe with one end passing through the shell is provided on the motor base; a combustion-supporting wind wheel is provided on one end of the motor base facing the combustion device, a motor is provided on the other end of the motor base, and an auxiliary wind wheel is provided on one end of the motor far from the motor base.

8. The parking heater with a high energy utilization rate according to claim 7, wherein the exhaust gas pipeline is wound around the periphery of the motor, one end of the exhaust gas pipeline is connected with the exhaust port, and the other end of the exhaust gas pipeline passes through the shell to be communicated with the outside.

9. A parking heater with a high energy utilization rate, comprising a shell and a combustion device, wherein
the combustion device is installed in the shell and has a gap, which is set as an air flow channel, and the shell is provided with at least one air inlet end communicated with the air flow channel; and
the combustion device comprises a cylinder body and an exhaust gas pipeline, and the cylinder body is provided with a combustion chamber and a fuel pipeline;
wherein, the fuel pipeline is configured for communicating with the combustion chamber and providing fuel, and the exhaust gas pipeline is configured for communicating with the combustion chamber and receiving exhaust gas; and
the combustion chamber comprises a combustion cylinder with a cylindrical structure with a varying axial diameter, and the fuel pipeline is continuously formed around the cylindrical structure of the combustion cylinder; and
the exhaust gas pipeline extends to the air inlet end and is continuously formed around an air inlet channel of the air inlet end.

10. The parking heater with a high energy utilization rate according to claim 9, wherein the shell comprises a first shell and a second shell which are detachably connected.

11. The parking heater with a high energy utilization rate according to claim 10, wherein at least one fixing slot is provided on the first shell, at least one fixing block corresponding to the fixing slot is provided on the second shell, and the first shell and the second shell are detachably connected with the fixing block through the fixing slot.

12. The parking heater with a high energy utilization rate according to claim 9, wherein the cylinder body is connected with a motor assembly; the motor assembly comprises a motor base connected with the cylinder body, and the other end of the motor base is provided with a motor.

13. The parking heater with a high energy utilization rate according to claim 12, wherein the motor base is provided with at least one first fixing hole, the cylinder body is provided with at least one second fixing hole corresponding to the first fixing hole, and the motor base and the cylinder body are fixedly connected through a first fixing element.

14. The parking heater with a high energy utilization rate according to claim 12, wherein a motor slot is formed on the motor base, and the motor is provided in the motor slot; the motor is provided with at least one third fixing hole, the motor base is provided with at least one fourth fixing hole corresponding to the third fixing hole, and the motor base and the motor are fixedly connected through a second fixing element.

15. The parking heater with a high energy utilization rate according to claim 10, wherein one side of the cylinder body is provided with a pipeline fixing platform, which is provided with a first groove for fixing the exhaust gas pipeline, a second groove for fixing an air inlet pipe and a third groove for fixing the fuel pipeline.

16. The parking heater with a high energy utilization rate according to claim 15, wherein the first shell is provided with an accommodating slot for accommodating the pipeline fixing platform, which is provided with at least one fifth fixing hole, and the accommodating slot is provided with at least one sixth fixing hole corresponding to the fifth fixing hole; and the first shell and the pipeline fixing platform are fixedly connected through a third fixing element.

17. The parking heater with a high energy utilization rate according to claim 9, wherein the combustion chamber comprises a combustion seat and an ignition device installed on the combustion seat, and the combustion cylinder is sleeved at the other end of the combustion seat.

18. The parking heater with a high energy utilization rate according to claim 17, wherein the combustion seat is provided with at least one seventh fixing hole, and the cylinder body is provided with at least one eighth fixing hole corresponding to the seventh fixing hole; and the combustion seat and the cylinder body are fixedly connected through a fourth fixing element.

19. A parking heater with a high energy utilization rate, comprising a shell and a combustion device, wherein
the combustion device is installed in the shell and has a gap, which gap is set as an air flow channel, and the shell is provided with at least one air inlet communicated with the air flow channel; and
the combustion device comprises a cylinder body and an exhaust gas pipeline, and the cylinder body is provided with a combustion chamber and a fuel pipeline;
wherein, the fuel pipeline is configured for communicating with the combustion chamber and providing fuel, and the exhaust gas pipeline is configured for communicating with the combustion chamber and receiving exhaust gas; and
the exhaust gas pipeline extends to the air inlet end and is continuously formed around an air inlet channel of the air inlet end.

20. The parking heater with a high energy utilization rate according to claim 19, wherein the cylinder body is provided with an exhaust port, and a motor assembly close to the air inlet end is installed on the cylinder body; the exhaust gas pipeline is wound around the periphery of the motor assembly and communicated with the exhaust port, and the other end of the exhaust gas pipeline passes through the shell and is communicated with the outside.
